(19) United States
(12) Patent Application Publication
(10) Pub. No.: US 2010/0310100 A1
(43) Pub. Date: Dec. 9, 2010

(54) LOUDSPEAKER INPUT SWITCH SYSTEM TO REORIENT SOUND IN TRUCK

(75) Inventors: Ryan Jagger, Columbia City, IN (US); Matt Hormann, Ft. Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/477,401

(22) Filed: Jun. 3, 2009

(51) Int. Cl. H04R 5/02

(52) U.S. Cl. 381/307; 381/123; 381/120; 381/86

(57) ABSTRACT

A loudspeaker input switch system for a truck cabin includes set of loudspeakers arranged in a perimeter arrangement, and an amplifier for amplifying signals from both a stereo player with a forward front-of-stage simulation, and a surround sound player with a front-of-stage simulation rotated 90° from the forward direction. A switching mechanism is used to selectively control the amplifier to change orientation of the front-of-stage simulation. A stereo music program can be played oriented correctly for a user driving the truck and a surround sound program can be played correctly oriented for a user turned 90° from the driving position.

### TECHNICAL FIELD OF THE INVENTION

The invention pertains to audio systems, particularly audio systems inside the cabins of commercial hauling trucks.

### BACKGROUND OF THE INVENTION

Many trucks in the commercial hauling industry include music audio systems inside the truck's cabin so the driver can listen to music during driving. Accordingly, a music program such as a radio signal, a cd player signal or an MP3 player signal is amplified by an audio system amplifier and broadcast through loudspeakers arranged in the cabin. Typically, the music program is in stereo wherein the signal comprises a right channel and a left channel and the audio system amplifier has a right channel section and a left channel section and the loudspeakers are arranged according to the left channel and the right channel to the left and right of the driver while driving, providing a stereo effect to the driver.

The truck cabins are also often large so as to provide sources of leisure for the driver during rest periods. The truck cabins can include a TV/DVD system. Due to the spatial dimensions of a typical truck cabin, the TV or video screen is optimally located along the left or right wall of the cabin, a distance behind the driver's seat, so that during viewing of a TV/DVD program the driver can reorient himself 90° from a driving orientation, into a comfortable, un-cramped location in a seat near the wall opposite the video screen, facing the video screen.

Many current TV/DVD programs have a surround sound soundtrack. Such sound tracks can be as described in U.S. Pat. Nos. 5,896,358; 5,602,923; 5,717,765; 6,624,873 and 6,760,448 and are commercially available as the DOLBY 5.1 or 6.1 surround sound systems. According to these systems, sound that corresponds to the action on the video program emanates from multiple loudspeakers which can include right front, center front, left front, left side, left back, right back, right side, and a subwoofer.

Proper surround sound loudspeaker programming and loudspeaker placement corresponds to the video program occurring simultaneously on the TV screen. For example, action on the screen that moves from left to right has a corresponding sound program that moves from left to right through the left loudspeaker, center loudspeaker and right loudspeaker. The moving sound adds realism to the video programming to achieve a movie theater-like experience for the viewer. This is also true for sound source placement located front, rear, left side or right side throughout a horizontal plane, or sound movements between left and right and front and back and variations thereof.

It is advantageous and cost effective that the audio programming from the TV/DVD surround sound be amplified and broadcast by the same sound system electronics and loudspeakers that are used for the music audio system.

The present inventors have recognized that current truck music audio systems present a problem with regard to the orientation of the audio signals to the driver's ears when used to reproduce both stereo sound during driving, and surround sound soundtracks corresponding to a video program played during rest. If the TV screen is oriented along the right wall of the cabin and the driver sits near the left wall facing the TV, then the loudspeakers in front of the driver are configured to provide only a right-front and right-back program given that the loudspeakers that were formerly on his right while he was driving. The loudspeakers now behind the driver are providing left-front and left-back programs as the loudspeakers were formerly on his left while he was driving. In other words, due to the 90° reorientation of the driver to observe the video screen, the sound programming of the loudspeakers is rotated 90° from proper surround sound programming loudspeaker locations.

This setup does not provide the optimal surround-sound system to transmit the audio signals of a movie or TV show. Not only would the loudspeakers fail to provide surround-sound, but it would have the right side sounds of the movie or TV show coming from the front, and the left side sounds of the movie or TV show coming from behind. This sound setup would be inconsistent with the video programming and would be confusing for the viewer.

The present inventor has recognized the need for an audio system that can be re-oriented depending on what direction the listener is facing.

The present inventor has recognized the need for an audio system that can be switched between stereophonic sound and surround sound depending on the listener's preferences.

### SUMMARY OF THE INVENTION

The present invention provides a loudspeaker system that includes a switching ability between a stereo system facing one direction, and a surround sound system facing a different direction. The system includes a common set of loudspeakers, whose inputs can be reoriented according to the nature of the desired sound.

Preferably, the stereophonic loudspeaker system includes three right side loudspeakers, three left side loudspeakers, and a subwoofer. The surround sound loudspeaker system includes three front loudspeakers, three rear loudspeakers, and the same subwoofer. This set of loudspeakers, if used in the cabin of a truck, can provide the driver with stereophonic sound oriented forward toward the engine of the truck while he is driving and listening to music. Alternatively, there is a switching mechanism which can be engaged that turns the loudspeakers into a surround sound system facing one of the side walls of the cabin where a TV is located. This, along with a TV/DVD system provides a movie theatre-like experience for the driver, usable by the driver when the truck is at rest.

In an exemplary embodiment, the TV or video screen is located near the right wall of the cabin, so when the switch is engaged to convert from the stereophonic system to the surround sound system, the right front, right side, and right rear loudspeakers change to take their inputs from the TV/DVD's front left, front center, and front right audio signals respectively. Also, the left front, left side, and left rear loudspeakers change to take their inputs from the TV/DVD's rear left, rear center, and rear right audio signals respectively.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a schematic plan view of the audio system of the present invention;

FIG. 2 is a schematic diagram of the audio system of the present invention; and

FIG. 3 is an alternate schematic diagram of the audio system of the present invention.

### DETAILED DESCRIPTION OF THE PREFERRED EMBODIMENT

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

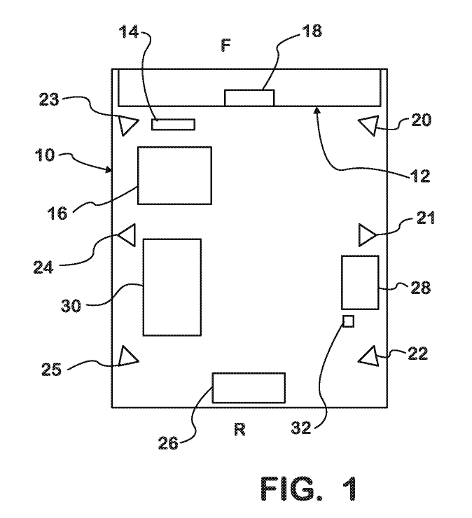

FIG. 1 shows the interior of a commercial hauling truck cabin 10, with dashboard 12, steering wheel 14, and driver's seat 16. FIGS. 1-3 indicate front of the cab “F” (toward the engine) and rear of the cab “R.” While driving, the driver sits on driver's seat 16 and faces forward toward steering wheel 14. Music player 18 generates a pre-amplified signal that is amplified by an amplifier 19 and played through loudspeakers 20-25 and subwoofer 26. The music player could be a radio receiver, a cd or dvd player, an mp3 player, or other stereo signal producing device. When played in stereo mode, the audio system plays right front, right side, and right rear audio from the music system through loudspeaker 20, loudspeaker 21 and loudspeaker 22 respectively. The loudspeakers 20, 21 and 22 can all be playing the same music program or the program can be changed somewhat from front to back to create ambient sound effects. The audio system plays left front, left side, and left rear audio from the music system through loudspeaker 23, loudspeaker 24, and loudspeaker 25. The loudspeakers 23, 24 and 25 can all be playing the same music program or the program can be changed somewhat from front to back to create ambient sound effects. The bass from the program material played by the audio system is played through a subwoofer 26.

When the driver is not driving, the driver can use a TV/DVD system 28, connected to a surround sound processor 29, for entertainment. When doing so, he will sit on leisure seat 30, reoriented 90° clockwise and face the TV/DVD system 28. When oriented in this direction, a switching mechanism 32 may be engaged by the driver and this will reorient the audio inputs to the loudspeakers, or “front-of-stage” by 90° clockwise. The inputs change so that loudspeaker 20 receives the left front audio, loudspeaker 21 receives the center front audio, and loudspeaker 22 receives the right front audio. Also, loudspeaker 23 will receive the rear left audio, loudspeaker 24 receives the rear center audio, and loudspeaker 25 receives the rear right audio. When the driver resumes driving, the switching mechanism 32 may be again actuated, so loudspeakers 20, 21, and 22 once again receive the right front, right side, and right rear stereophonic audio respectively, and loudspeakers 23, 24, and 25 once again receive the left front, left side, and left rear stereophonic audio respectively. The bass from the program material played by the audio system is played through the subwoofer 26.

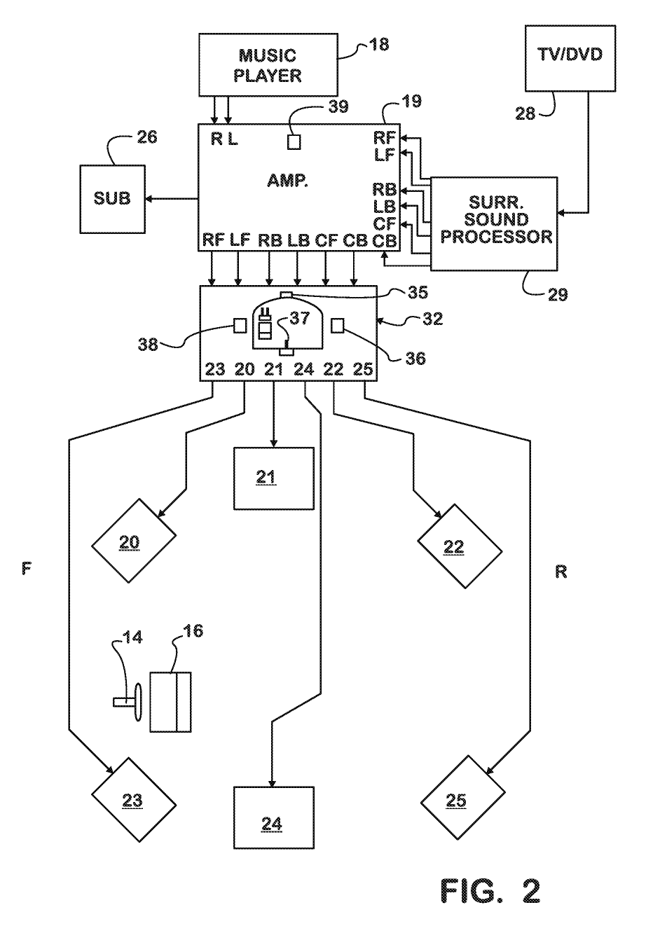

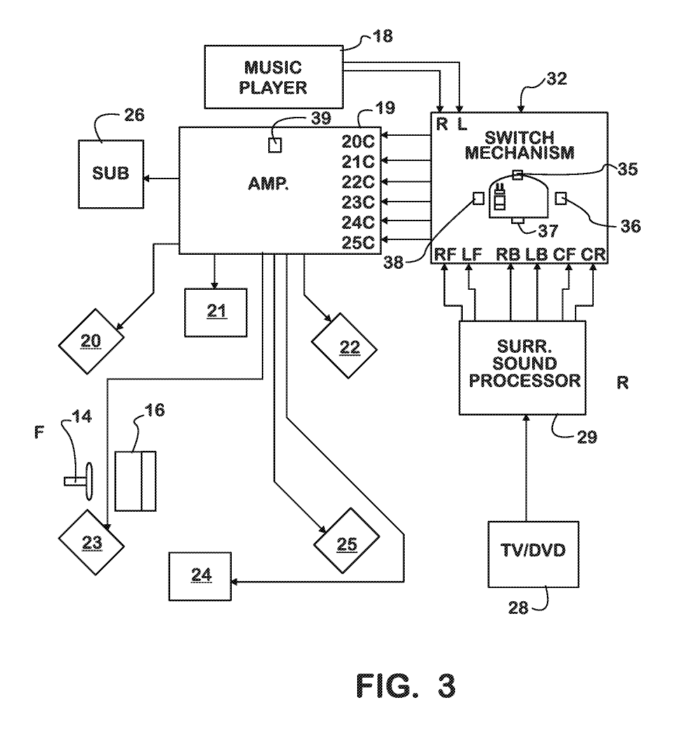

The invention encompasses the switching mechanism 32 switching either high-level (amplified) loudspeaker inputs (FIG. 2) or low-level (pre-amplified) amplifier imports (FIG. 3).

In the case of switching high-level loudspeaker inputs (FIG. 2), the switching mechanism 32 can comprise multiple contact switches, micro-switches, an electronic circuit, or a controller with selectable states which can be reconfigured to reassign the amplified loudspeaker signal outputs from the music system amplifier, which terminate at the terminals for each loudspeaker. The switching mechanism can have a graphic thereon of the cabin with push buttons 35, 36, 37, 38 for selecting the front-of-stage for a selected user orientation. For driving and listening to music, the button 35 would be pushed and front of stage would be the front “F” of the cabin. If the video screen is on the right wall, the button 36 would be selected. Buttons 37 and 38 could be provided to rotate the front-of-stage further increments of 90° for further flexibility in arranging the cabin seating and user orientations.

A surround sound on/off button 39 can be incorporated into the amplifier 19, or remote control thereof, such that either a stereophonic signal (left and right channels) is provided to the switching mechanism 32 (surround off) or a surround sound signal (left front, center front, right front, right back, center back, left back) is provided to the switching mechanism (surround on).

If the button 35 is selected for stereophonic listening while driving, and the surround button is in the off position, the switching mechanism 32 assigns high level signals from the audio amplifier such that loudspeakers 20, 21 and 23 receive the signal R (right channel) from the music player 18, amplified by the audio system amplifier 19, and the loudspeakers 23, 24 and 25 receive the signal L (left channel) from the music player, amplified by the audio system amplifier 19.

The surround button 39 could also be in the “on” position if this is the desired mode of listening while listening in this orientation.

If the button 36 is selected, the orientation of the loudspeaker assignments is rotated 90° clockwise, and if the surround button 39 is in the on position, the loudspeaker 20 is left front, loudspeaker 21 is front center, loudspeaker 22 is right front, loudspeaker 25 is right back, loudspeaker 24 is center back, and loudspeaker 23 is left back according to a surround sound program. The surround button 39 could alternately be in the “off” position if stereo is the desired mode of listening while listening in this orientation, such as for music listening.

FIG. 3 illustrates an alternate configuration wherein instead of the high level loudspeaker signals, the pre-amplified signals from the music player and the TV/DVD are switchable by the switching mechanism 32 and the desired front-of-stage is selectable by the buttons 35, 36, 37, 38. The signals from the music player 18 and the TV/DVD processor 29 are selectively switched before being amplified by the amplifier 19. The correctly selected and oriented signals from the switching mechanism 32 are provided to inputs 20c, 21c, 22c, 23c, 24c and 25c that correspond to the loudspeakers 20, 21, 22, 23, 24 and 25. In other words according to this embodiment the amplifier channels are always associated with the same loudspeaker and the pre-amplified signals into the amplifier are selectively changed to change the front-of-stage orientation and to change stereo or surround sound signals.

If the button 35 is selected for stereophonic listening while driving, and the surround button is in the “off” position, the switching mechanism 32 assigns low level signals from the switching mechanism 32 to the audio amplifier 19 such that loudspeakers 20, 21 and 23 receive the signal R (right channel) from the music player 18, amplified by the audio system amplifier 19, and the loudspeakers 23, 24 and 25 receive the signal L (left channel) from the music player, amplified by the audio system amplifier 19.

The surround button 39 could also be in the “on” position if this is the desired mode of listening while listening in this orientation.

If the button 36 is selected, the orientation of the loudspeaker assignments is rotated 90° clockwise, and if the surround button 39 is in the on position, the switching mechanism 32 assigns low level signals from the switching mechanism 32 to the audio amplifier 19 such that the loudspeaker 20 is left front, loudspeaker 21 is front center, loudspeaker 22 is right front, loudspeaker 25 is right back, loudspeaker 24 is center back, and loudspeaker 23 is left back according to a surround sound program. The surround button 39 could alternately be in the “off” position if stereo is the desired mode of listening while listening in this orientation, such as for music listening.

Although the switching mechanism 32 is shown as a separate “box” schematically, it could be incorporated into the amp 19 or a remote control associated with the amp 19. Also, the music player 18, and/or the amp 19, and/or the surround sound processor 29, and/or the TV/DVD, and/or the switching mechanism 32 could be integrated into one or more chassis or housings.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A loudspeaker input switch system for a vehicle comprising:
a set of loudspeakers arranged in a perimeter arrangement;
an amplifier that drives said loudspeakers according to first signals simulating a front-of-stage in a first orientation and alternately according to second signals simulating a front-of-stage in a second orientation arranged at an angle of rotation from said first orientation;
a music player that communicates said first signals to said amplifier;
a surround sound processor that communicates said second signals to said amplifier; and
a switching mechanism that selectively controls the amplifier to drive the loudspeakers according to either said first or second signals.

2. The loudspeaker input switch system of claim 1, wherein said perimeter formation of said loudspeakers comprises a rectangular grid layout of said loudspeakers.

3. The loudspeaker input switch system of claim 1, wherein said music player comprises a radio.

4. The loudspeaker input switch system of claim 1, wherein said music player comprises a CD player.

5. The loudspeaker input switch system of claim 1, comprising one player selected from the group of television, video cassette player, digital video disc (DVD) player, wherein said player is signal connected to said surround sound processor.

6. The loudspeaker input switch system of claim 1, wherein said first signals comprise left and right loudspeaker inputs for a stereophonic audio system.

7. The loudspeaker input switch system of claim 1, wherein said second signals comprise front left, front right, front center, rear left, rear right, and rear center loudspeaker signals.

8. The loudspeaker input switch system of claim 1, wherein said angle of rotation is about 90°.

9. The loudspeaker input system of claim 8, wherein said first signals are stereo signals having different signals left and right, and said second signals are surround sound signals having different signals left and right and front and back.

10. The loudspeaker input system of claim 1, wherein said switching mechanism comprises a button or switch.

11. A loudspeaker input switch system for a truck cabin having a front, a passenger side, a driver side and a rear comprising:
a first loudspeaker arranged near a corner of said front and said driver side, a second loudspeaker arranged near a corner of said front and said passenger side, a third loudspeaker arranged near a corner of said rear and said passenger side, and a fourth loudspeaker arranged near a corner of said rear and said driver side;
an amplifier that drives said loudspeakers according to a first set of signals with said first loudspeaker corresponding to left of a stereo music program, and said second loudspeaker corresponding to right of a stereo music program, and alternately, according to a second set of signals with said first loudspeaker corresponding to rear left of a surround sound program, said second loudspeaker corresponding to front left of a surround sound program, said third loudspeaker corresponding to front right of a surround sound program, and said fourth loudspeaker corresponding to rear right of a surround sound program;
a music player that communicates said first set of signals to said amplifier;
a surround sound processor that communicates said second set of signals to said amplifier; and
a switching mechanism that selectively controls the amplifier to drive the loudspeakers according to either said first or second set of signals.

12. The loudspeaker input switch system of claim 10, wherein said music player comprises a radio.

13. The loudspeaker input switch system of claim 10, wherein said music player comprises a CD player.

14. The loudspeaker input switch system of claim 10, comprising one player selected from the group of television, video cassette player, digital video disc (DVD) player, wherein said player is signal connected to said surround sound processor.

15. The loudspeaker input switch system of claim 10, further comprising a fifth loudspeaker located between said second and third loudspeakers that is arranged to be driven by said second set of signals and corresponds to a front center of a surround sound program.

16. The loudspeaker input switch system of claim 15, further comprising a sixth loudspeaker located between said first and fourth loudspeakers that is arranged to be driven by said second set of signals and corresponds to a rear center of a surround sound program.

17. The loudspeaker input system of claim 10, wherein said switching mechanism comprises a button or switch.
